(19) United States
(12) Patent Application Publication
(10) Pub. No.: US 2012/0292574 A1
(43) Pub. Date: Nov. 22, 2012

(54) Process For The Production Of Hydrogen And Carbon Dioxide

(75) Inventors: Paul Terrien, Philadelphia, PA (US); Trapti Chaubey, Wilmington, DE (US); Purushottam V. Shanbhag, Claymont, DE (US); Bhadra S. Grover, Sugar Land, TX (US); Dennis A. Vauk, Houston, TX (US); Arthur Darde, Paris (FR); Pascal Marty, Bry Sur Marne (FR)

(73) Assignees: Air Liquide Large Industries U.S. LP, Houston, TX (US); L'Air Liquide Societe Anonyme Pour L'Etude Et L'Exploitation Des Procedes Georges Claude, Paris (FR)

(21) Appl. No.: 13/169,270

(22) Filed: Jun. 27, 2011

Related U.S. Application Data
(60) Provisional application No. 61/487,509, filed on May 18, 2011.

(51) Int. Cl. C01B 3/32

(52) U.S. Cl. 252/373

(57) ABSTRACT

This present invention provides a method to more efficiently recover hydrogen and carbon dioxide, preferably at least 50%, even more preferably at least 75%, and most preferably at least 90% of the carbon dioxide. The present invention further provides the design for capture of at least 80%, carbon dioxide from syngas that allows for the simultaneous production of medium to high amounts of hydrogen in the syngas as a part of the production of hydrogen in a hydrogen generation plant. By using the process of the present invention, especially in terms of a hydrogen generation plant, it is possible to increase recovery of hydrogen and capture of the carbon dioxide in the syngas stream by balancing the recycle of the hydrogen rich permeate from the hydrogen membrane separation units to the process unit and/or the water gas shift as capacity allows when a carbon dioxide separation unit, a carbon dioxide membrane separation unit and two hydrogen membrane separation units are utilized.

### CROSS-REFERENCE TO RELATED APPLICATIONS

This application claims priority to U.S. Provisional Patent Application No. 61/487,509 filed May 18, 2011, the entire content of each incorporated herein by reference.

### FIELD OF THE INVENTION

The present invention relates to a process for recovering hydrogen and carbon dioxide from a process stream utilizing a carbon dioxide separation unit and three membrane separation units. The present invention further provides for a process within a hydrogen generation plant to increase recovery of hydrogen and capture equal to or greater than 80% of the carbon dioxide in the syngas stream utilizing a carbon dioxide separation unit and three membrane separation units.

### BACKGROUND

Hydrogen is an important feedstock for many chemical and petrochemical processes. However, hydrogen production is associated with large amounts of carbon dioxide emissions. Accordingly, it is desirable to not only provide a means to produce hydrogen but also a means to recover the carbon dioxide associated with the hydrogen production. With increased emission regulations and a possible future carbon dioxide tax there is a need to develop carbon dioxide capture solutions. The cost of capture can impact the cost of hydrogen production. Therefore, it is important to develop a solution with lower cost of capture and improved efficiency of hydrogen production plant.

Physical or chemical solvents such as rectisol, selexol, amines, potassium carbonate etc. have been used traditionally for many decades to absorb carbon dioxide from syngas in hydrogen plants, HYCO (hydrogen and carbon monoxide co-production) plants. However, the process of solvent absorption requires absorber and stripper column with very high capital costs. The scrubbing solvent needs to be regenerated by temperature swing or pressure swing in order to release the absorbed carbon dioxide. The regeneration process can involve large amounts of steam or compression energy resulting in high operating costs. Another disadvantage of using the solvent absorber is that the purity of the recovered carbon dioxide may not be very high and further processing using liquefaction and partial condensation may be needed. Example U.S. Pat. No. 6,500,241 describes the use of acid gas removal unit and auto refrigeration unit for removing carbon dioxide from syngas and pressure swing adsorption off-gas. U.S. Pat. No. 4,553,981 and U.S. Pat. No. 7,682,597 describe the use of a carbon dioxide scrubber downstream of the shift reactor to remove carbon dioxide from syngas.

Carbon dioxide can be captured from hydrogen plant by using cryogenic processing viz. partial liquefaction or distillation at low temperature. Such a process is favorable at higher carbon dioxide concentrations. In hydrogen plants, carbon dioxide can be captured from several different locations in the process train including process syngas or flue gas. Flue gas processing can pose several challenges because of many new impurities that therefore make the capture process very expensive. Carbon dioxide from process gas can be captured from high pressure syngas before pressure swing adsorption unit or from pressure swing adsorption off-gas. The concentration of carbon dioxide in the gas before pressure swing adsorption is much lower than in the pressure swing adsorption off-gas and hence the pressure swing adsorption off-gas is more suitable for cryogenic separation. U.S. Pat. No. 6,301,927 provides an example of an auto refrigeration process that employs the use of a compression and expansion turbine to liquefy carbon dioxide and further separate it from other gases. Another patent, FR Patent No. 2877939 provides a way to remove carbon dioxide from pressure swing adsorption off-gas by using successive steps of compression and cooling to remove carbon dioxide by partial liquefaction and/or distillation. This patent describes the use of a membrane on the non-condensable gas to permeate hydrogen and recycle hydrogen back to the pressure swing adsorption unit in order to increase hydrogen recovery. However, carbon dioxide recovery for the unit is not very high. In U.S. Pat. No. 4,639,257, provides the use of carbon dioxide selective membrane in combination with distillation column for a carbon dioxide containing gas mixture in order to increase the recovery of carbon dioxide. A carbon dioxide selective membrane is used on the overhead of the distillation column with carbon dioxide rich permeate recycled back to feed or to the distillation column itself. Another carbon dioxide selective membrane is proposed for the feed gas before the distillation column in case the concentration of carbon dioxide is below equilibrium concentration at the freezing temperature of the mixture. However, this patent is suitable for a gas mixture containing carbon dioxide, nitrogen, methane and hydrocarbon. U.S. Patent Publication No. 2010/0129284, describes the use of a hydrogen selective membrane, a carbon dioxide selective membrane in combination with carbon dioxide liquefier in order to increase the recovery of hydrogen and carbon dioxide. However, carbon dioxide selective membrane is always located upstream of the liquefier requiring additional compression of the carbon dioxide permeate from the membrane feeding to the liquefier.

Hydrogen plants can emit large quantities of carbon dioxide into the atmosphere. Carbon dioxide capture solutions have been proposed in the past using several different separation techniques like absorption, cryogenic, adsorption or membrane. There is always some hydrogen loss from pressure swing adsorption processes. In addition, there is some carbon dioxide loss from the capture process which can be recovered by improving the carbon dioxide capture process. If additional hydrogen and carbon dioxide can be recovered from the capture process there can be significant savings with regards to the size of reformer, natural gas consumption, carbon dioxide tax etc. for the same size hydrogen plant.

Accordingly, there still exists a need for a process to recover both hydrogen and carbon dioxide with a carbon dioxide recovery rate of at least 50% from syngas, as well as a process for producing hydrogen in a hydrogen generation plant that allows for the overall capture of at least 80% of the carbon dioxide, in the hydrogen production process.

### SUMMARY

This present invention provides a method to more efficiently recover hydrogen and carbon dioxide, preferably at least 50%, even more preferably at least 75%, and most preferably at least 90% of the carbon dioxide. The present invention further provides the design for capture of at least 80%, carbon dioxide from syngas that allows for the simultaneous production of medium to high amounts of hydrogen in the syngas as a part of the production of hydrogen in a hydrogen generation plant. By using the process of the present invention, especially in terms of a hydrogen generation plant, it is possible to increase recovery of hydrogen and capture of the carbon dioxide in the syngas stream by balancing the recycle of the hydrogen rich permeate from the hydrogen membrane separation units to the process unit and/or the water gas shift as capacity allows when a carbon dioxide separation unit, a carbon dioxide membrane separation unit and two hydrogen membrane separation units are utilized. The proposed use combines hydrogen selective membranes and carbon dioxide selective membranes together with a carbon dioxide separation unit such that hydrogen and carbon dioxide are produced with increased recoveries and improved process efficiency, especially with regard to a hydrogen generation plant. Increased hydrogen recovery by using hydrogen selective membranes can reduce the size of the feed gas producing unit, natural gas consumption for feed and fuel etc for the same size hydrogen plant. Increased carbon dioxide recovery will reduce the emissions of carbon dioxide into the atmosphere and will result in cost savings in case of a carbon tax.

### DETAILED DESCRIPTION OF THE DRAWINGS

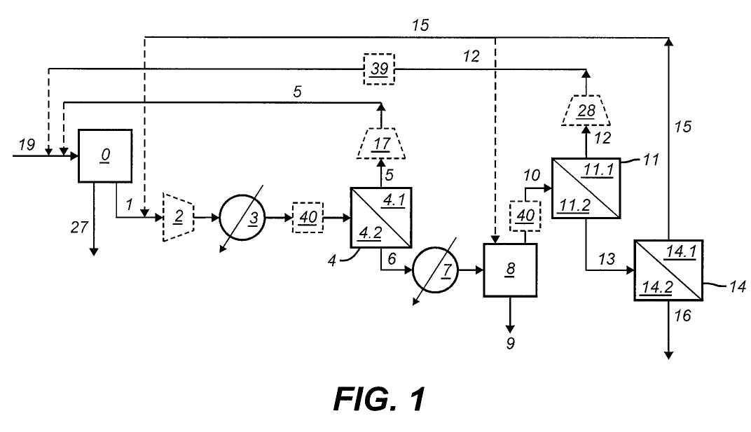

FIG. 1 provides a schematic of one embodiment of the present process.

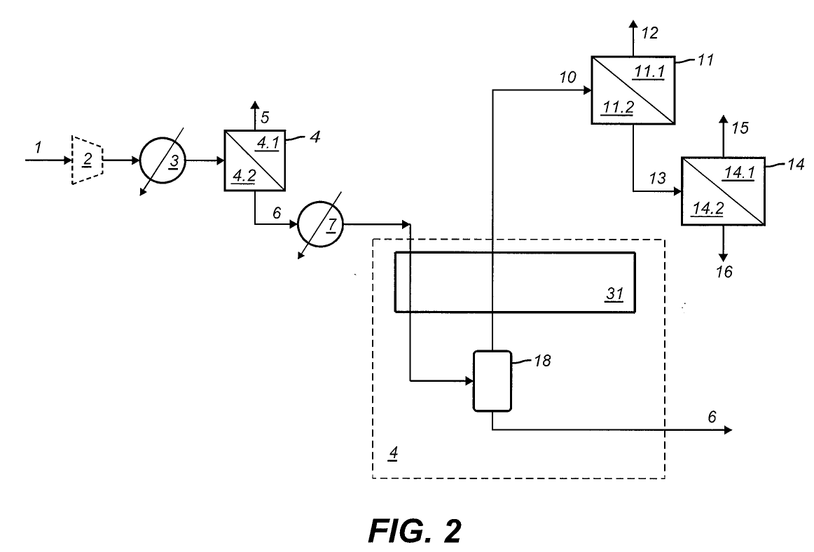

FIG. 2 provides an expanded view of one variation of the carbon dioxide separation unit of FIG. 1.

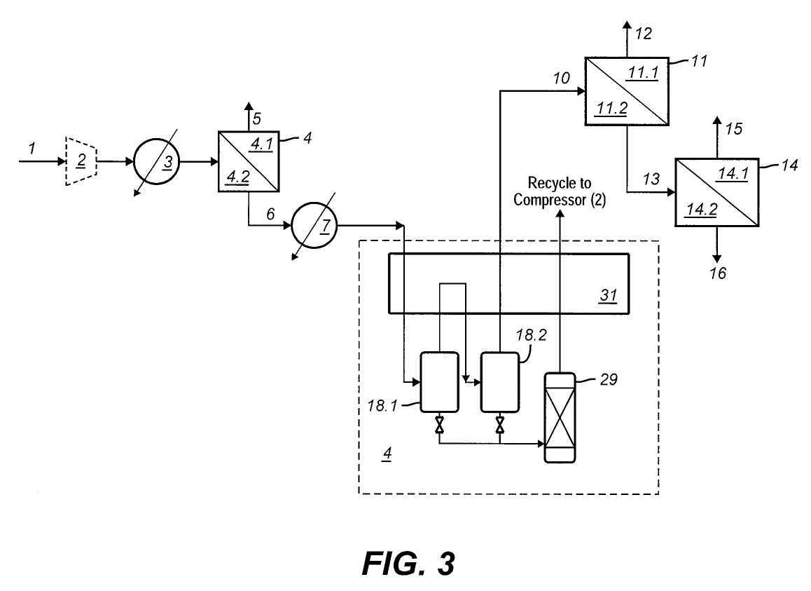

FIG. 3 provides an expanded view of another variation of the carbon dioxide separation unit of FIG. 1.

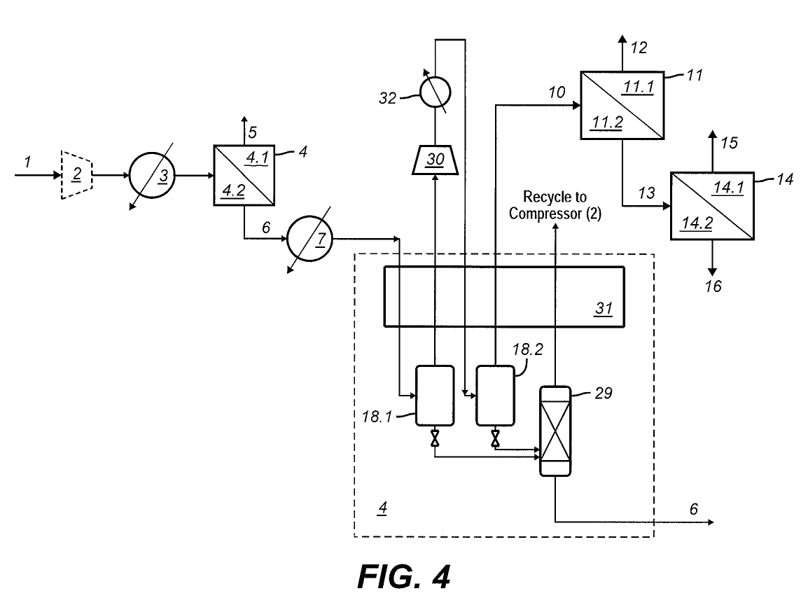

FIG. 4 provides an expanded view of still a further variation of the carbon dioxide separation unit of FIG. 1.

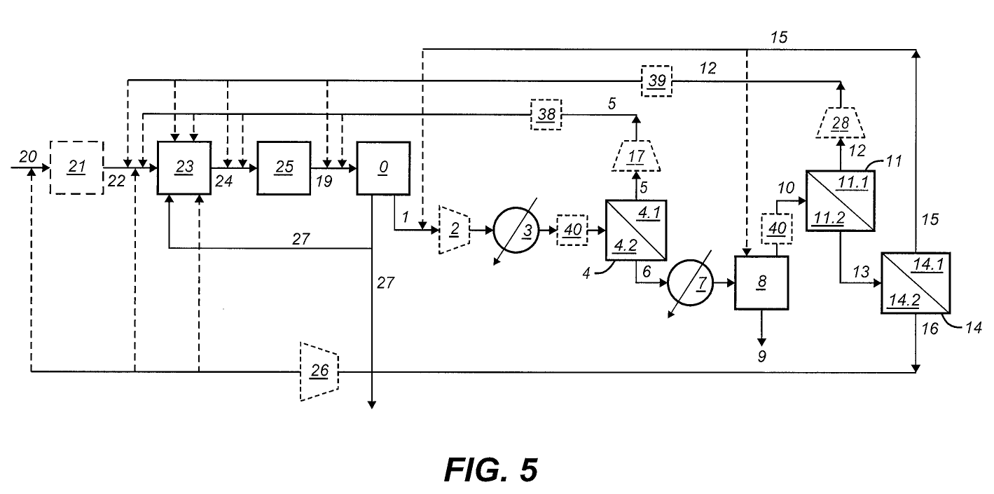

FIG. 5 provides a schematic of a second embodiment of the present process.

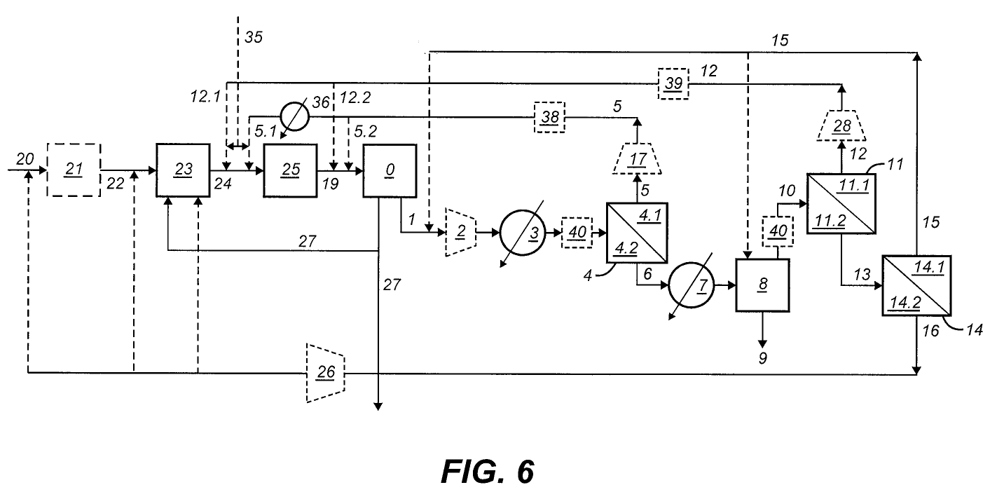

FIG. 6 provides an alternative to the schematic of FIG. 5.

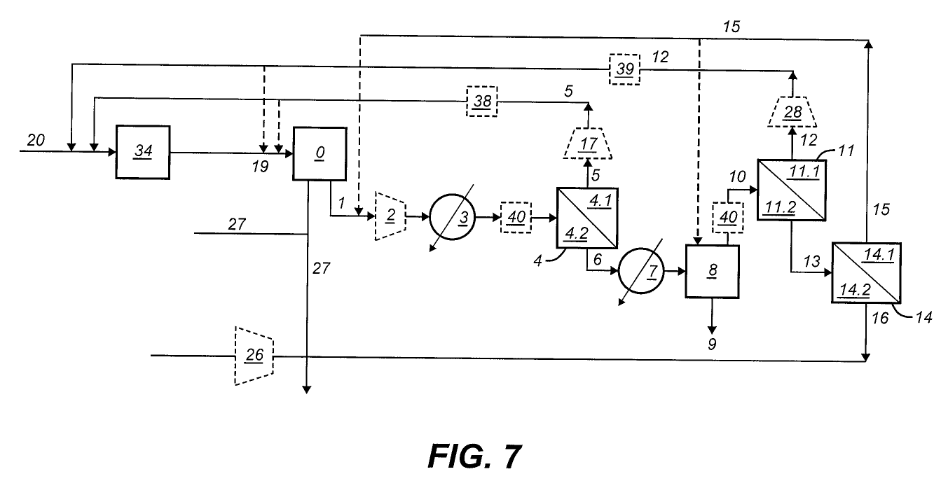

FIG. 7 provides an alternative to the schematic of FIG. 1.

### DETAILED DESCRIPTION OF THE INVENTION

It is possible to efficiently recover hydrogen and carbon dioxide from process streams obtained from process units which have a purification step that provides a hydrogen rich fraction which can be utilized downstream (more specifically, in the production of electricity) as in the present process. While overcoming many of the disadvantages of the prior art systems that deal with the recovery of hydrogen and carbon dioxide from such streams, this can be accomplished by integrating a first hydrogen selective membrane separation unit, a carbon dioxide separation unit, a second hydrogen selective membrane separation unit and a carbon dioxide selective membrane separation unit into the process for treating streams taken from such process units in the manner noted herein in order to recover hydrogen and at least 50% of the carbon dioxide present in the stream being treated. In addition, increased production of hydrogen and carbon dioxide capture of equal to or greater than 80% from syngas in hydrogen generation plants may also be accomplished by integrating a first hydrogen selective membrane separation unit, a carbon dioxide separation unit, a second hydrogen selective membrane separation unit and a carbon dioxide selective membrane separation unit into the schematic of a hydrogen generation plant. Accordingly, two main processes are proposed herein.

With regard to the first noted process, the proposed schematic includes a process unit, an optional compressor, a first heat exchanger, a first hydrogen selective membrane separation unit, a second heat exchanger, a carbon dioxide separation unit, a second hydrogen selective membrane separation unit and a carbon dioxide selective membrane separation unit. With regard to the second noted process, the proposed schematic includes a feed gas producing unit, a pressure swing adsorption unit, an optional compressor, a first heat exchanger, a first hydrogen selective membrane separation unit, a second heat exchanger, a carbon dioxide separation unit, a second hydrogen selective membrane separation unit and a carbon dioxide selective membrane separation unit.

The processes of the present invention will be further described with regard to the figures contained herein. These figures are included merely for illustration purposes and are not intended in any way to limit the processes of the present invention. The first process of the present invention as depicted in FIG. 1 involves the recovery of hydrogen and carbon dioxide from a process stream (1) that is obtained from a process unit (0). As used herein, the phrase “process unit” refers to any unit which includes a purification step that results in the production of a hydrogen rich fraction that can be used downstream. More specifically, the “process unit” is a unit in which as one step of the process, hydrogen is removed from a feed stream in such a manner that allows for the recovery of hydrogen in a more concentrated form than presented in the original noted feed stream—a hydrogen rich fraction that is the product stream (27)—and a tail gas stream that is the process stream (1).

The feed gas (19) that is supplied to the process unit (0) can be any feed stream that will typically be subjected to treatment for the removal of hydrogen. For example, the feed gas (19) may be a feed gas (19) produced in a feed gas producing unit (34), for example a feed gas (19) from a reformer unit/water gas shift unit, a partial oxidation unit (POx), an autothermal reformer unit (ATR), syngas from a coal gasification unit, refinery off gas or any other gas mixture that contains hydrogen, carbon monoxide and carbon dioxide as components in the gas mixture. In the more typical situation, the feed gas (19) will be the product of a hydrocarbon containing feed stream (20) that has been subjected to a reformer unit/water gas shift unit, an ATR unit, a POx unit or a gasification unit. In the more preferred siguation, the feed gas (19) will be the product of a hydrocarbon containing feed stream (20) that has been subjected to at least steam hydrocarbon reforming (preferably steam methane reforming) (not shown in FIG. 1). In a further embodiment, the feed gas (19) will be the product of a hydrocarbon containing feed stream (20) that has been subjected to at least steam hydrocarbon reforming and water gas shift (not shown in FIG. 1). In a still further embodiment, the feed gas (19) will be the product of a gas stream that has been subjected to pre-reforming and steam hydrocarbon reforming and finally, the product of a gas stream that has been subjected to pre-reforming, steam hydrocarbon reforming and water gas shift (not shown in FIG. 1). Each of these is described more specifically below with regard to the second process. In addition, those of ordinary skill in the art will recognize that the present invention is not meant to be limited by the hydrocarbon feed stream (20) which will ultimately form the feed gas (19) utilized in the present invention. Depending upon the source of the hydrocarbon feed streams (20), those of ordinary skill in the art will recognize that there will likely be small amounts of other components present in the ultimate feed gas (19), e.g. inerts such as nitrogen. Accordingly, while reference is made herein in more general terms to the major components (such as hydrogen, carbon monoxide, carbon dioxide, methane and water vapor) of the hydrocarbon feed streams (20) and feed gas (19), those skilled in the art will recognize that inerts such as nitrogen are also present and make up part of the stream.

Preferably, the process unit (0) utilized will be a pressure swing adsorption unit that is used to recover and purify hydrogen, although those skilled in the art will recognize that any other unit that functions to carry out hydrogen purification may is also contemplated to be within the scope of the present invention. The pressure swing adsorption unit utilized can be any pressure swing adsorption unit known in the art and can comprise anywhere from two to twelve adsorption beds (not shown) although more adsorption beds may be utilized. During the process of hydrogen purification, each of the adsorption beds (not shown) will individually under go a cycle that comprises: a) pressurization with pure hydrogen product, b) constant feed and hydrogen product release; c) pressure equalization to transfer high pressure hydrogen-rich void gas to another bed at low pressure, the other bed being about to commence product pressurization; d) depressurization to slightly above atmospheric pressure; e) purge using product hydrogen; and f) pressure equalization with another bed at higher pressure to accept hydrogen-rich void gas. Preferably the adsorbents used in the pressure swing adsorption unit (0) include, but are not limited to, activated alumina, activated carbon, zeolite and their combinations. As a result of hydrogen purification, two separate gas streams are obtained—one that is a gaseous medium to very high purity hydrogen stream that is withdrawn and used as a hydrogen product (27) and the other which is often referred to as a pressure swing adsorption tail gas (referred to hereinafter as the “process stream”) which is withdrawn after desorption of the adsorption bed as process stream (1). The process stream (1) is withdrawn from the adsorption beds of the pressure swing adsorption unit during the depressurization and purge steps. As used herein, the phrase “medium to very high purity hydrogen stream” refers to greater than 99% hydrogen. Furthermore, as used herein, the phrase “high purity hydrogen stream” refers to greater than 99.9% hydrogen.

The removal of hydrogen product (27) from the feed gas (19) in the process unit (0) results in a process stream (1) that is purged from the process unit (0). This process stream (1) contains at least carbon dioxide, hydrogen and methane. Typically, the process stream contains at least methane, carbon monoxide, carbon dioxide, water, and any unrecovered hydrogen.

In the process of the present invention as depicted in FIG. 1, the process stream (1) obtained from the process unit (0) is further treated to remove additional hydrogen and carbon dioxide by passing the process stream (0) through a first hydrogen selective membrane separation unit, a carbon dioxide separation unit (4), a second hydrogen selective membrane unit (7) and a carbon dioxide selective membrane unit (10).

Prior to being introduced into the first hydrogen selective membrane separation unit (4), the process stream (1) obtained is optionally compressed in a first compressor (2). As used throughout, the term “compressor” is meant to include not only a compressor that has a single stage for compression but also a compressor that includes multiple stages for compression (typically from two to eight stages) with means for cooling between the various stages of the compressor. Note that the number of stages necessary to achieve the desired level of compression (pressure) depends on the inlet/outlet pressure ratio. Such determinations are readily apparent (determinable) to those skilled in the art. The degree of compression at this stage of the process (prior to the cooling of the stream) will depend in part upon the type of hydrogen selective membrane utilized as well as the configuration of the carbon dioxide separation unit (8). More specifically, when the carbon dioxide separation unit (4) does not include a compressor, the process stream (1) will be compressed to a pressure equal to or greater than 35 bar prior to the cooling in the heat exchanger (3) of the present process as depicted in FIG. 1. However, when the carbon dioxide separation unit (4) does include a compressor as a component of the carbon dioxide separation unit (4) which allows for the process stream (1) to be compressed either prior to or as a part of the actual separation and purification steps within the carbon dioxide separation unit (4), then only partial compression or no compression will take place prior to the cooling step in the heat exchange (3) of the present process (thereby making the compression of the process stream (1) optional before being introduced into the carbon dioxide separation unit (4)). The intent is to have a process steam (1) that is at a pressure equal to or greater than 35 bar while being treated in the carbon dioxide separation unit (4). More specifically, in order to accomplish this degree of compression, the process stream (1) may be compressed in a variety of manners. For example, the process stream (1) may be compressed in whole (to equal to or greater than 35 bar) or in part (compression to a pressure less than 35 bar in compressor (2) but when further compressed downstream (in a compressor that is a component of the carbon dioxide separation unit (4)) achieves a level of compression that is equal to or greater than 35 bar) provided that the final pressure of the process stream (1) is equal to or greater than 35 bar. For example, for a process stream (1) that is at a pressure of 20 bar, it may be possible to increase the pressure in the compressor (2) to 30 bar prior to the cooling of the stream in the heat exchanger (3) and then raise the pressure to 37 bar in the compressor that is a component of the carbon dioxide separation unit (4). Preferably, the process stream (1) is compressed to above 50 bar while being treated in the carbon dioxide separation unit (4). Most of the compression, if not all, is preferably accomplished in the compressor (2) prior to cooling (before being introduced into the carbon dioxide separation unit (4)). Those skilled in the art will recognize that the addition compressor (not shown) while being a part of the carbon dioxide separation unit (4) will for practical reasons, typically be positioned outside of the cold box of the carbon dioxide separation unit (4) (separated from those components that are typically at less than ambient temperature). In addition to the options of the process stream (1) being compressed to the desired pressure, or being partially compressed to the desired pressure (and further compressed in the carbon dioxide separation unit (4)), or not being compressed (and being fully compressed in the carbon dioxide separation unit (4)), those skilled in the art will recognize that in certain instances, it may be desirable to utilize/treat a portion or fraction of the process stream (1) while in other instances it may be desirable to utilize/treat the entire process stream (1). Accordingly, when compression takes place, only that fraction that will be utilized/treated will typically be compressed.

Prior to being optionally compressed, the process stream (1) may optionally be passed through one or more filters, including a series of filters (not shown) in order to remove any adsorbent that may have passed through from the process unit (0). Those skilled in the art will recognize that a variety of different types of filters may be utilized to filter the process stream, including, but not limited to, ceramic filters, bayhouses, metallic filters, etc.

The temperature of the optionally compressed process stream (1) is then adjusted to a temperature from about 20° C. to about 150° C. by subjecting the process stream (1) to heat exchange in a first heat exchanger (3). In a preferred embodiment, the temperature of the process stream (1) is adjusted to a temperature from about 20° C. to about 100° C. Any type of heat exchanger (3) that is known in the art may be utilized to cool the process stream (1) to the desired temperature. Once this temperature is obtained, the temperature adjusted process stream (1) is passed through a first hydrogen selective membrane separation unit (4) to form a first hydrogen rich permeate stream (5). As used herein with regard to the first hydrogen rich permeate stream (5), the phrase “hydrogen rich” refers to the permeate stream having a percentage of hydrogen that is greater than the percentage of the other components in the hydrogen rich permeate stream (5). The hydrogen selective membrane preferentially permeates hydrogen over carbon monoxide, carbon dioxide, methane and nitrogen as well as any other components in the stream being subjected to the hydrogen selective membrane. In the preferred embodiment of the present process, the hydrogen selective membrane utilized has a hydrogen permeability that is at least 1.25, preferably 5, more preferably 8 and even more preferably 12, times that of the gas or gases from which the hydrogen is separated under the chosen operating conditions. Fluid permeation through a polymeric membrane can be described as the overall mass transport of a fluid species across the membrane, where the fluid species is introduced as feed at a higher pressure than the pressure on the opposite of the membrane, which is commonly referred to as the permeate side of the membrane.

Typically in a separation process, the fluid species is a mixture of several components, at a minimum two, with the membrane exhibiting a higher selectivity for one component (for example “component A”) over the other component (for example “component B”). Component A permeates faster than component B, therefore relative to the feed, the permeate is enriched in component A and the portion of the feed that does not permeate, commonly referred to as the retentate or residue is enriched in component B. With regard to this particular invention, the fluid is in a gaseous form and the polymeric continuous phase of the active membrane layer is nonporous. By “nonporous” it is meant that the continuous phase is substantially free of cavities or pores formed in a network through which migrating components of the gas mixture may flow from the feed to the permeate side of the membrane.

Transmembrane rate of transport of migrating components through the polymeric continuous phase is commonly referred to as flux and is driven primarily by molecular solution/diffusion mechanisms.

Preferably, the polymer is selectively gas permeable to the components, meaning that the gases to be separated from each other permeate the membrane at different rates. That is, a highly permeable gas will travel a distance through the continuous phase faster than will a less permeable gas. The selectivity of a gas permeable polymer is the ratio of the permeabilities of the individual component gases, e.g. Permeability of component A to permeability of component B. Hence, the greater the difference between transmembrane fluxes of individual components, the larger will be the component pair selectivity of a particular polymeric membrane.

With regard to the present process, the permeate stream that is obtained will generally contain from about 40% to about 90% hydrogen with the remaining part of the permeate stream comprising the other components contained in the process stream (1). Accordingly, a “hydrogen rich” permeate stream will generally contain greater than or equal to 40% hydrogen, preferably up to or greater than 90% hydrogen. In an alternative embodiment of the present process, the process stream (1) can be treated in the hydrogen selective membrane separation unit (4) at low pressure in order to increase the recovery of hydrogen. As used herein with regard to the process stream (1), the phrase “low pressure” refers to a pressure that is equal to or less than 10 bar, preferably from about equal to or less than 1 bar absolute to less than 10 bar. Note that when the process stream (1) is permeated at low pressure, the pressure of the process stream (1) can be adjusted by any method known in the art such as one or more valves, a turbine, etc. (not shown). In a still further embodiment, the process stream (1) is permeated at the same pressure as the process stream (1) from the process unit (0) is separated and purified in the carbon dioxide separation unit (4).

The remaining components in the process stream (1) form a first hydrogen lean residue stream (6). As used herein with regard to the hydrogen lean residue stream (6), the phrase “hydrogen lean” refers to the residue stream having a percentage of hydrogen that is less than that in the process stream (1).

The hydrogen selective membrane separation unit (4) utilized in the process of the present invention contains at least one membrane that is selective for hydrogen over the other components in the process stream (1). Note that the target molecule, in this case hydrogen, determines how the permeate stream is used. With regard to each of the membranes utilized in the present process, each membrane has a permeate side (4.1) and a residue side (4.2). Since the membrane is selective for hydrogen, it allows for the passing of hydrogen through the membrane to the permeate side (4.1) of the membrane. While a variety of different types of membranes may be utilized in the hydrogen selective membrane separation unit (4) of the process of the present invention, the preferred membrane is a polymeric membrane that is selective for hydrogen, the polymeric membrane being selected from one or more polyamides, polyaramides, polybenzimidazoles, polybenzimidazole blends with polyimides, polyamides/imides. Hydrogen selective membranes will have a H₂/CO₂ selectivity given by the ratio of H₂ permeance to the CO₂ permeance at the operating conditions that is greater than 1.25, preferably greater than 5, more preferably greater than 8.

The hydrogen selective membranes of the present invention can be fabricated into any membrane form by any appropriate conventional method. For example, the hydrogen selective membranes may be cast as a sheet at the desired thickness onto a flat support layer (for flat sheet membranes), or extruded through a conventional hollow fiber spinneret (for hollow fiber membranes). Processes for preparing uniformly dense membranes or asymmetric membranes are also available and known to those skilled in the art. In addition, it is possible to prepare composite membranes by casting or extruding the membrane over a porous support of another material in either flat film or hollow fiber form. The separating layer of the composite membrane can be a dense ultra-thin or asymmetric film. In the preferred embodiment of the present process, the hydrogen selective membranes are in the form of modules comprising membranes formed as either hollow fibers or spiral wound asymmetric flat sheets.

The first hydrogen selective membrane separation unit (4) includes at least one of the above noted membranes. With regard to the actual configuration of the first hydrogen selective membrane separation unit (4), the first hydrogen selective membrane separation unit (4) can take on any number of configurations. In one embodiment, there is only one membrane element in the first hydrogen selective membrane separation unit (4). In an alternative embodiment, the first hydrogen selective membrane separation unit (4) comprises a series of hydrogen selective membrane elements within a single membrane housing (not shown). With regard to this embodiment, the series of hydrogen selective membranes can be made up of hydrogen selective membranes of the same type selected from the hydrogen selective membranes detailed above or of two or more different hydrogen selective membranes selected from the hydrogen selective membranes detailed above. In the embodiment where there are two or more hydrogen selective membranes, the hydrogen selective membranes will preferably be of the same type and the same fabrication (for example, sheets or fibers). In a still further embodiment concerning the configuration of the first hydrogen selective membrane separation unit (4), the first hydrogen selective membrane separation unit (4) comprises two or more membrane housings with each of the housings having one or more hydrogen selective membranes as described hereinbefore. More specifically, in this embodiment, there can be two or more membrane housings, with each of the housings having either one hydrogen selective membrane or two or more hydrogen selective membranes of the same type or two or more hydrogen selective membranes of two of more different types. The resulting hydrogen selective membranes may be mounted in any convenient type of housing or vessel adapted to provide a supply of the process stream (1), and removal of the first permeate stream (4.1) and first residue stream (4.2). The housing also provides a high-pressure side (for the process stream (1) and the first residue stream) and a low-pressure side of the hydrogen selective membrane (for the first permeate stream). As an example of configurations contemplated to be within the present invention, flat-sheet membranes can be stacked in plate-and-frame modules or wound in spiral-wound modules. Hollow-fiber membranes can be potted with a thermoset resin in cylindrical housings. The final first hydrogen selective membrane separation unit (4) comprises one or more membrane modules or housings, which may be housed individually in pressure vessels or multiple elements may be mounted together in a sealed housing of appropriate diameter and length.

As noted above, as a result of passing the process stream (1) through the first hydrogen selective membrane separation unit (4), two separate streams are formed—a first hydrogen rich permeate stream (5) and a first hydrogen lean residue stream (6). The first hydrogen rich permeate stream (5) is optionally compressed in a second compressor (17) before being recycled for use as a supplemental feed stream for the process unit (0). In addition, the hydrogen rich permeate stream (5) may also be used as a supplemental feed stream for the process unit (0) or as a supplemental feed stream for other processes upstream. More specifically, in the preferred embodiment, the hydrogen rich permeate stream (5) is utilized as two separate fractions—as a first hydrogen rich permeate fraction (5.1) to be used as a supplemental feed stream for processes that are upstream of the process unit (0) (not shown) and as a second hydrogen rich permeate fraction (5.2) to be used as a supplemental feed stream in the process unit (0) (not shown) with the objective being to optimize the use of the recycle stream (5) in order to maximize the conversion of carbon monoxide to carbon dioxide and hydrogen. With regard to this particular embodiment, the proportion of each fraction recycled to the corresponding devices (0, and what ever device is upstream) depends upon the percentage of production (the load) from the feed gas producing unit. Those of ordinary skill in the art will recognize that a number of different factors can contribute to the determination of the load including, but not limited to, the design of the plant and the size of the various components of the feed gas producing unit, the process unit (0), heat exchangers, carbon dioxide removal unit, etc. Preferably the conversion of carbon monoxide to carbon dioxide and hydrogen is maximized utilizing a portion of the recycle stream (5.1) while the remaining portion of the recycle stream (5.2) is sent to the process unit (0). This is accomplished by first directing the flow of the hydrogen rich permeate stream (5) to be added to the stream that is to be fed into the feed gas producing unit. The optimum solution is to split the hydrogen rich permeate stream (5) with one part or fraction going to the feed gas producing unit and the other part or fraction going to the stream to be introduced into the process unit.

With regard to the additional streams, while the hydrogen product stream (27) is recovered as product, as in the previous embodiments, a portion of this stream (27) can be used for hydrogen fueling of the feed gas producing unit (34). In a still further modification to this embodiment, it is advantageous to further heat the first hydrogen rich permeate fraction (5.1) prior to this stream being added as a supplemental feed to the feed gas producing unit.

In the next step of the process, the first hydrogen lean residue stream (6) that is obtained form the first hydrogen selective membrane separation unit (4) is then cooled to a temperature that is equal to or less than −10° C. by subjecting the first hydrogen lean residue stream (6) to heat exchange in a second heat exchanger (7). Those skilled in the art will recognize that while the heat exchanger (7) of FIG. 1 is positioned outside of the carbon dioxide separation unit (8), this heat exchanger (7) for all practical purposes is considered to be a part of the carbon dioxide separation unit (8). In a preferred embodiment, the first hydrogen lean residue stream (6) is cooled to a temperature that is equal to or less than −30° C. Any type of heat exchanger (7) that is known in the art may be utilized to cool the first hydrogen lean residue stream (6) to the desired temperature.

The next step of the process involves the separation and purification of the cooled first hydrogen lean residue stream (6) in a carbon dioxide separation unit (8) to produce a carbon dioxide rich liquid stream (9) and a carbon dioxide lean non-condensable stream (10). The carbon dioxide separation unit (8) may be any unit which is capable of separating/purifying carbon dioxide from a stream that contains carbon dioxide at a temperature that is equal to or less than −10° C., preferably equal to or less than −40° C. In other words, the carbon dioxide separation occurs at sub-ambient temperatures and conditions. Those of ordinary skill in the art recognize that such sub-ambient separation/purification is known in the art. Accordingly, the present process is not meant to be limited by the carbon dioxide separation unit (8) or the process for carrying out the separation/purification in the carbon dioxide separation unit (8). As used throughout with regard to the present invention, the phrase “carbon dioxide separation unit” refers not only to the liquefaction units and/or distillation columns included therein, but also to all of the additional components that typically are considered to make up a carbon dioxide separation unit (8), including, but not limited to, one or more components selected from additional heat exchangers, additional compressors, dryers, etc.

With regard to the present carbon dioxide separation unit (8), the separation/purification is typically carried out utilizing single or multi-step partial liquefaction as depicted in FIG. 2 which includes one liquefaction unit (18); single or multi-step partial liquefaction in combination with at least one distillation column as depicted in FIG. 3 which includes two liquefaction units (a first liquefaction unit 18.1 and a second liquefaction unit 18.2) and one distillation column (29); and single or multi-step partial liquefaction in combination with at least one distillation column and at least one compressor and/or heat exchanger as depicted in FIG. 4 which includes two liquefaction units (a first liquefaction unit 18.1 and a second liquefaction unit 18.2), one distillation column (29), one compressor (30) and one heat exchanger (31). When two or more liquefaction units (18) are included in the carbon dioxide separation unit (8), it should be noted that liquefaction within each of these units may take place at the same temperature or at different temperatures. In any event, the temperature for such liquefaction will generally be between about −10° C. and −57° C., preferably between about −30° C. and −57° C. In addition, note that with regard to FIG. 4, while the compressor (30) and heat exchanger (31) are outside of the box (8) which denotes the carbon dioxide separation unit (8), they are still considered to be a part of the carbon dioxide separation unit (8) and are simply included where they are for feasibility purposes (outside of the cold box).

As a result of the separation/purification that takes place in the carbon dioxide separation unit (8), there is produced a carbon dioxide lean non-condensable stream (10) and a carbon dioxide rich liquid stream (9). The carbon dioxide rich liquid stream (9) is withdrawn from the carbon dioxide separation unit (8) as a product stream and directed for further use as a carbon dioxide product. In addition, note that while cooling in the heat exchanger (31) of the carbon dioxide separation unit (8) can be accomplished utilizing an external coolant such as ammonia, the carbon dioxide rich liquid stream (9) may also be used, prior to the stream being withdrawn from the carbon dioxide separation unit (8), to provide cooing within the heat exchanger (31) of the carbon dioxide separation unit (8). Those of ordinary skill in the art will recognize that such streams will typically include from about 90% to more than 99.9% carbon dioxide and may be used for enhanced oil recovery, industrial uses, sequestration in geological formations, etc. This carbon dioxide rich liquid stream (9) can be utilized as a liquid or may be vaporized to produce a carbon dioxide rich gas stream.

The carbon dioxide non-condensable stream (10) that is withdrawn from the carbon dioxide separation unit (8) is typically at a high or medium pressure since the first hydrogen lean residue stream (6) treated in the carbon dioxide separation unit (8) will be at a pressure that is equal to or greater than 35 bar. As used herein with regard to the carbon dioxide non-condensable stream (10), the phrase “high pressure” refers to a pressure that ranges from about 50 bar to about 100 bar, preferably from about 50 bar to about 80 bar. As used herein with regard to the carbon dioxide non-condensable stream (10), the phrase “medium pressure” refers to a pressure that ranges from about 10 bar to about 49 bar, preferably from about 25 bar to about 49 bar.

Once the carbon dioxide lean non-condensable stream (10) is withdrawn from the carbon dioxide separation unit (8), it is passed through a second hydrogen selective membrane separation unit (11) where the hydrogen passes through the hydrogen selective membrane to form a second hydrogen rich permeate stream (12). As used herein with regard to the second hydrogen rich permeate stream (12), the phrase “hydrogen rich” refers to the second permeate stream having a percentage of hydrogen that is greater than the percentage of the other components in the second hydrogen rich permeate stream (12). As with the hydrogen selective membrane of the first hydrogen selective membrane separation unit (4), the hydrogen selective membrane of the second hydrogen selective membrane separation unit (8) preferentially permeates hydrogen over carbon monoxide, carbon dioxide and methane as well as any other components in the stream being subjected to the hydrogen selective membrane. In the preferred embodiment of the present process, the hydrogen selective membrane utilized in the second hydrogen selective membrane separation unit (8) has a hydrogen permeability that is at least 1.25, preferably 5, more preferably 8 and even more preferably 12, times that of the gas or gases from which the hydrogen is separated under the chosen operating conditions. Accordingly, with regard to the present process, the second permeate stream that is obtained will generally contain from about 40% to about 90% hydrogen with the remaining part of the permeate stream comprising the other components contained in the carbon dioxide non-condensable stream (10). In an alternative embodiment of the present process, the carbon dioxide non-condensable stream (10) can be treated in the second hydrogen selective membrane separation unit (11) at low pressure in order to increase the recovery of hydrogen. As used herein with regard to the carbon dioxide non-condensable stream (10), the phrase “low pressure” refers to a pressure that is equal to or less than 10 bar, preferably from about equal to or less than 1 bar absolute to less than 10 bar. Note that when the carbon dioxide non-condensable stream (10) is permeated at low pressure, the carbon dioxide non-condensable stream (10) pressure is reduced (as it will be at high to medium pressure) by any method known in the art such as one or more valves, a turbine, etc. (not shown). In a still further embodiment, the first hydrogen rich permeate stream (12) is permeated at the same pressure as the feed gas (19) of the process unit (0).

The remaining components in the carbon dioxide lean non-condensable stream (10) form a second hydrogen lean residue stream (13). As used herein with regard to the second hydrogen lean residue stream (13), the phrase “hydrogen lean” refers to the second residue stream having a percentage of hydrogen that is less than that in the carbon dioxide non-condensable stream (10).

The second hydrogen selective membrane separation unit (11) utilized in the process of the present invention contains at least one membrane that is selective for hydrogen over the other components in the carbon dioxide lean non-condensable stream (10). Note that the target molecule, in this case hydrogen, determines how the permeate stream is used. With regard to each of the hydrogen selective membranes utilized in the second hydrogen selective membrane separation unit (11) of the present process, each membrane has a permeate side (11.1) and a residue side (11.2). Since the membrane is selective for hydrogen, it allows for the passing of hydrogen through the membrane to the permeate side (11.1) of the membrane. While a variety of different types of membranes may be utilized in the second hydrogen selective membrane separation unit (11) of the process of the present invention, as with the first hydrogen selective membrane separation unit (4), the preferred membrane is a polymeric membrane that is selective for hydrogen and is selected from one or more polyamides, polyaramides, polybenzimidazoles, polybenzimidazole blends with polyimides, polyamides/imides. Hydrogen selective membranes will have a H₂/CO₂ selectivity given by the ratio of H₂ permeance to the CO₂ permeance at the operation conditions that is greater than 1.25, preferably greater than 5, and more preferably greater than 8. In a preferred embodiment of the present invention, the polymeric membranes of the first hydrogen selective membrane separation unit (4) and the second hydrogen selective membrane separation unit (11) will be made of the same polymeric materials.

As with the first hydrogen selective membrane separation unit (4), the second hydrogen selective membrane separation unit (11) includes one or more hydrogen selective membranes, each membrane having a permeate side (11.1) and a residue side (11.2) and allowing for the passing of hydrogen to the permeate side (11.1) of the membrane to form the hydrogen rich permeate stream (12) with the remaining components in the carbon dioxide non-condensable stream (10) forming the second hydrogen lean residue stream (13) on the residue side (11.2) of the membrane. As with the first hydrogen selective membrane separation unit (4), in the present second hydrogen selective membrane separation unit (10), the result of passing the carbon dioxide lean non-condensable stream (10) through the second hydrogen selective membrane separation unit (11) is a second hydrogen rich permeate stream (12) and a second hydrogen lean residue stream (13). With regard to the phrases “hydrogen rich” and “hydrogen lean” in terms of the second hydrogen selective membrane separation unit (11), these phrases have the same meaning as with regard to the phrases as they apply to the first hydrogen selective membrane separation unit (4).

As noted above, as a result of passing the carbon dioxide non-condensable stream (10) through the second hydrogen selective membrane separation unit (11), two separate streams are formed—a second hydrogen rich permeate stream (12) and a second hydrogen lean residue stream (13). The hydrogen rich permeate stream (12) is optionally compressed in a third compressor (28) before being recycled for use as a supplemental feed stream for the process unit (0). In addition, the hydrogen rich permeate stream (12) may also be used as a supplemental feed stream for other processes besides that of the present invention. As with the first permeate stream (5), the second hydrogen rich permeate stream (12) can be utilized as two separate fractions—as a first-second hydrogen rich permeate fraction (12.1) to be used as a supplemental feed stream for processes that are upstream of the process unit (0) (not shown) and as a second-second hydrogen rich permeate fraction (12.2) to be used as a supplemental feed stream in the process unit (0) (not shown) with the objective being to optimize the use of the recycle stream (12) in order to maximize the conversion of carbon monoxide to carbon dioxide and hydrogen. With regard to this particular embodiment, the proportion of each fraction recycled to the corresponding devices (0, and what ever device is upstream) depends upon the percentage of production (the load) from the feed gas producing unit. Those of ordinary skill in the art will recognize that a number of different factors can contribute to the determination of the load including, but not limited to, the design of the plant and the size of the various components of the feed gas producing unit, the process unit (0), heat exchangers, carbon dioxide removal unit, etc. Preferably the conversion of carbon monoxide to carbon dioxide and hydrogen is maximized utilizing a portion of the recycle stream (12.1) while the remaining portion of the recycle stream (12.2) is sent to the process unit (0). This is accomplished by first directing the flow of the second hydrogen rich permeate stream (12) to be added to the stream that is to be fed into the feed gas producing unit. The optimum solution is to split the second hydrogen rich permeate stream (12) with one part or fraction going to the feed gas producing unit and the other part or fraction going to the stream to be introduced into the process unit.

With regard to the additional streams, while the hydrogen product stream (27) is recovered as product, as in the previous embodiments, a portion of this stream (27) can be used for hydrogen fueling of the feed gas producing unit (34). In a still further modification to this embodiment, it is advantageous to further heat the second hydrogen rich permeate fraction (12.1) prior to this stream being added as a supplemental feed to the feed gas producing unit.

In as still further embodiment, The permeate stream (12) may be combined with the permeate stream (5) from the first hydrogen selective membrane separation unit (4) before being recycled to be used as a supplemental feed stream for the process unit (0).

In the next step of the present process, the second hydrogen lean residue stream (13) is passed through a carbon dioxide selective membrane separation unit (14) in order to form a carbon dioxide enriched permeate stream (15). As used herein with regard to the carbon dioxide enriched permeate stream (15), the phrase “carbon dioxide enrich” refers to the permeate stream having a percentage of carbon dioxide that is greater than the percentage of the other components in the carbon dioxide enriched permeate stream (15).

The carbon dioxide selective membrane of the carbon dioxide selective membrane separation unit (14) is used to preferentially permeate carbon dioxide over carbon monoxide, methane and nitrogen as well as any other components in the stream being subjected to the carbon dioxide selective membrane. In the preferred embodiment of the present process, the carbon dioxide selective membrane utilized had a carbon dioxide permeability that is more than 5 times, preferably greater than 10 times and even more preferably greater than 20 times that of the gas or gases from which the carbon dioxide is separated under the chosen operating conditions, with the exception of the hydrogen.

The remaining components in the second hydrogen lean residue stream (13) form a carbon dioxide depleted residue stream (16). As used herein with regard to the carbon dioxide depleted residue stream (16), the phrase “carbon dioxide depleted” refers to the residue stream having a percentage of carbon dioxide that is less than that in the stream introduced into the carbon dioxide membrane separation unit (14) (the hydrogen lean residue stream (13)).

In a still further embodiment of the present invention, an optional second water gas shift reactor (38) may be installed along the line transporting the hydrogen rich permeate stream (5) from the first hydrogen membrane separation unit and/or an optional third water gas shift reactor (39) along the line transporting the hydrogen rich permeate stream (12) from the second hydrogen membrane separation unit in order to reduce the carbon monoxide that may be present in each stream (5, 12). It is especially preferred to reduce the level of carbon monoxide to such a low level that there is no further incentive to convert the carbon monoxide contained in one or more of the streams (5, 12), In the preferred embodiment, the water gas shift reactor (38) would be placed along the line transporting the hydrogen rich permeate stream (5) from the first hydrogen membrane separation unit. In each case, the water gas shift reactor (38, 39) would be a low temperature water gas shift reactor. As used herein, the phrase “low temperature water gas shift reactor” refers to a water gas shift reaction that generally occurs in the 180 to 240° C. range to further reduce carbon monoxide levels compared to the higher temperature water gas shift reactor which generally operates in a higher temperature range and is utilized to convert bulk (higher percentages) of carbon monoxide. Low temperature water gas shift reactors of the type contemplated in the present invention are known in the art and accordingly will not be described in great detail herein other than to not that such reactors require proper heating means (not shown) and steam injection (not shown). Furthermore, the size of the low temperature water gas shift reactor (38, 39) will depend upon the quantity of hydrogen rich permeate (5, 12) processed. Typically, this stream (5, 12) will be smaller in size than the quantity of the feed stream (19) processed.

The carbon dioxide selective membrane separation unit (14) utilized in the process of the present invention contains at least one membrane that is selective for carbon dioxide over the other components in the second hydrogen lean residue stream (13). Note that the target molecule, in this case carbon dioxide, determines how the permeate stream is used. With regard to each of the membranes utilized in the present process, each carbon dioxide selective membrane has a permeate side (14.1) and a residue side (14.2). Since the membrane is selective for carbon dioxide, it allows for the passing of carbon dioxide through the membrane to the permeate side (14.1) of the membrane.

While a variety of different types of membranes may be utilized in the carbon dioxide selective membrane separation unit (14) of the process of the present invention, the preferred membrane is a polymeric membrane that is selective for carbon dioxide that is selected from one or more polyimides, polyetherimides polysulfone, polyethersulfones, polyarylsulfone, polycarbonate, tetrabromo-bisphenol A polycarbonate, tetrachloro-bisphenol A polycarbonate, polydimethylsiloxane, natural rubber, cellulose actetate, cellulose triacetate, ethyl cellulose, PDD-TFE and polytriazole.

With regard to each of the carbon dioxide selective membranes utilized in the carbon dioxide selective membrane separation unit (14) of the present process, each carbon dioxide selective membrane has a permeate side (14.1) and a residue side (14.2). Since the membrane is selective for carbon dioxide, it allows for the passing of carbon dioxide through the membrane to the permeate side (14.1) of the membrane. While the membrane is selective for carbon dioxide, those skilled in the art will recognize that a minor portion of the other components in the second hydrogen lean residue stream (13) will also pass through the carbon dioxide selective membrane to become a part of the permeate. Accordingly, with regard to the present process, the permeate stream that is obtained will generally contain from about 40% to about 90% carbon dioxide with the remaining part of the permeate stream comprising the other components contained in the second hydrogen lean residue stream (13). As a result of passing the hydrogen lean residue stream (14) into the carbon dioxide selective membrane separation unit (14) and through the membrane, this stream is separated into two streams—one which is considered to be carbon dioxide enriched and one which is considered to be carbon dioxide depleted.

While a variety of different types of membranes may be utilized in the carbon dioxide selective membrane separation unit (14) of the process of the present invention, the preferred membrane is made of any number of polymers that are suitable as membrane materials. With regard to the membranes of the present invention, these polymers include, but are not limited to substituted or unsubstituted polymers selected from polysiloxane, polycarbonates, silicone-containing polycarbonates, brominated polycarbonates, polysulfones, polyether sulfones, sulfonated polysulfones, sulfonated polyether sulfones, polyimides and aryl polyimides, polyether imides, polyketones, polyether ketones, polyamides including aryl polyamides, poly(esteramide-diisocyanate), polyamide/imides, polyolefins such as polyethylene, polypropylene, polybutylene, poly-4-methyl pentene, polyacetylenes, polytrimethysilylpropyne, fluorinated polymers such as those formed from tetrafluoroethylene and perfluorodioxoles, poly(styrenes), including styrene-containing copolymers such as acrylonitrile-styrene copolymers, styrene-butadiene copolymers and styrene-vinylbenzylhalide copolymers, cellulosic polymers, such as cellulose acetate-butyrate, cellulose propionate, ethyl cellulose, methyl cellulose, cellulose triacetate, and nitrocellulose, polyethers, poly(arylene oxides) such as poly(phenylene oxide) and poly(xylene oxide), polyurethanes, polyesters (including polyarylates), such as poly(ethylene terephthalate), and poly(phenylene terephthalate), poly(alkyl methacrylates), poly(acrylates), polysulfides, polyvinyls, e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ketones), poly(vinyl ethers), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates), polyallyls, poly(benzobenzimidazole), polyhydrazides, polyoxadiazoles, polytriazoles: poly(benzimidazole), polycarbodiimides, polyphosphazines, and interpolymers, including block interpolymers containing repeating units from the above such as terpolymers of acrylonitrile-vinyl bromide-sodium salt of para-sulfophenylmethallyl ethers, and grafts and blends containing any of the foregoing. The polymer suitable for use is intended to also encompass copolymers of two or more monomers utilized to obtain any of the homopolymers or copolymers named above. Typical substituents providing substituted polymers include halogens such as fluorine, chlorine and bromine, hydroxyl groups, lower alkyl groups, lower alkoxy groups, monocyclic aryl, lower acyl groups and the like.

With regard to one embodiment of the present invention, the preferred polymers include, but are not limited to, polysiloxane, polycarbonates, silicone-containing polycarbonates, brominated polycarbonates, polysulfones, polyether sulfones, sulfonated polysulfones, sulfonated polyether sulfones, polyimides, polyetherimides, polyketones, polyether ketones, polyamides, polyamide/imides, polyolefins such as poly-4-methyl pentene, polyacetylenes such as polytrimethysilylpropyne, and fluoropolymers including fluorinated polymers and copolymers of fluorinated monomers such as fluorinated olefins and fluorodioxoles, and cellulosic polymers, such as cellulose diacetate and cellulose triacetate. Examples of preferred polyimides are Ultem 1000, P84 and P84-HT polymers, and Matrimid 5218.

Of the above noted polymeric membranes, the most preferred membranes are those made of polyimides. More specifically, polyimides of the type disclosed in U.S. Pat. No. 7,018,445 and U.S. Pat. No. 7,025,804, each incorporated herein in their entirety by reference. With regard to these types of membranes, the process of the present invention preferably utilizes a membrane comprising a blend of at least one polymer of a Type 1 copolyimide and at least one polymer of a Type 2 copolyimide in which the Type 1 copolyimide comprises repeating units of formula I

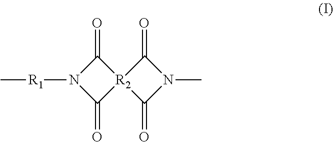

in which R₂ is a moiety having a composition selected from the group consisting of formula A, formula B, formula C and a mixture thereof,

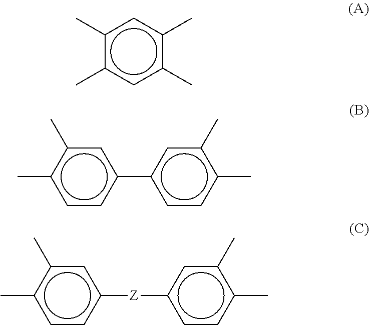

Z is a moiety having a composition selected from the group consisting of formula L, formula M, formula N and a mixture thereof; and

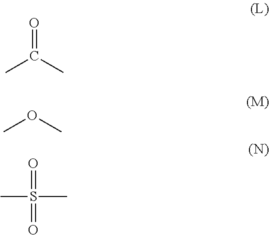

R₁ is a moiety having a composition selected from the group consisting of formula Q, formula S, formula T, and a mixture thereof,

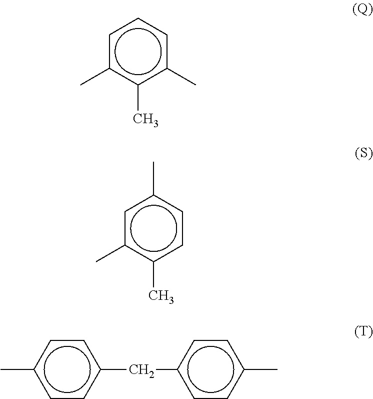

in which the Type 2 copolyimide comprises the repeating units of formulas IIa and IIb

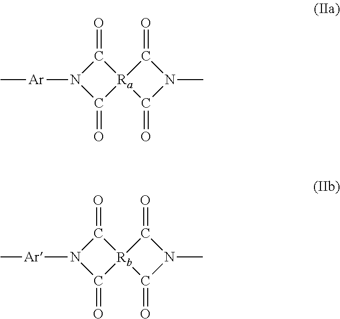

in which Ar is a moiety having a composition selected from the group consisting of formula U, formula V, and a mixture thereof,

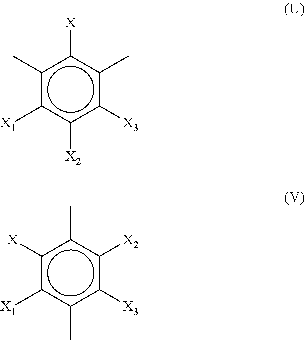

in which
X, X₁, X₂, X₃ independently are hydrogen or an alkyl group having 1 to 6 carbon atoms, provided that at least two of X, X₁, X₂, or X₃ on each of U and V are an alkyl group,
Ar′ is any aromatic moiety,
Rₐ and R_{b} each independently have composition of formulas A, B, C, D or a mixture thereof, and

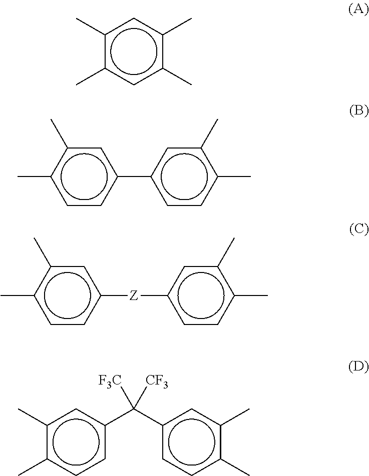

Z is a moiety having composition selected from the group consisting of formula L, formula M, formula N and a mixture thereof

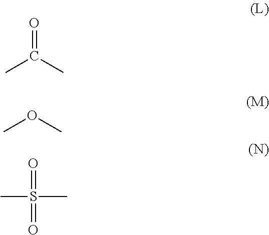

The material of the membrane consists essentially of the blend of these copolyimides. Provided that they do not significantly adversely affect the separation performance of the membrane, other components can be present in the blend such as, processing aids, chemical and thermal stabilizers and the like.

In a preferred embodiment, the repeating units of the Type 1 copolyimide have the composition of formula Ia.

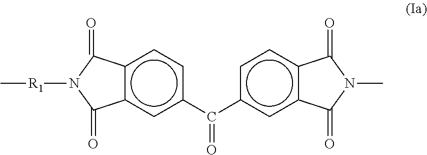

Wherein R₁ is as defined hereinbefore. A preferred polymer of this composition in which it is understood that R₁ is formula Q in about 16% of the repeating units, formula S in about 64% of the repeating units and formula T in about 20% of the repeating units is available from HP Polymer GmbH under the tradename P84

In another preferred embodiment, the Type 1 copolyimide comprises repeating units of formula Ib.

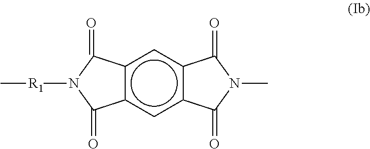

Wherein R₁ is as defined hereinbefore. Preference is given to using the Type 1 copolyimide of formula Ib in which R₁ is a composition of formula Q in about 1-99% of the repeating units, and of formula ₛ in a complementary amount totaling 100% of the repeating units.

In yet another preferred embodiment, the Type 1 copolyimide is a copolymer comprising repeating units of both formula Ia and Ib in which units of formula Ib constitute about 1-99% of the total repeating units of formulas Ia and Ib. A polymer of this structure is available from HP Polymer GmbH under the tradename P84-HT325.

In the Type 2 polyimide, the repeating unit of formula IIa should be at least about 25%, and preferably at least about 50% of the total repeating units of formula IIa and formula IIb. Ar′ can be the same as or different from Ar.

The polyimides utilized to form the membranes of the present process will typically have a weight average molecular weight within the range of about 23,000 to about 400,000 and preferably about 50,000 to about 280,000.

The carbon dioxide selective membranes of the present process can be fabricated into any membrane form by any appropriate conventional method as noted hereinbefore with regard to the hydrogen selective membranes (i.e., flat sheet membranes or hollow fiber membranes). While the carbon dioxide selective membranes do not have to be in the same form as the hydrogen selective membranes, in one preferred embodiment, the form of the carbon dioxide selective membranes is in the hollow fiber form and the hydrogen selective membranes are in the same form.

As with the hydrogen selective membrane separation units (4, 11), the carbon dioxide membrane separation unit (14) includes at least one of the above noted membranes. With regard to the actual configuration of the carbon dioxide selective membrane separation unit (14), the carbon dioxide selective membrane separation unit (14) can take on any number of different configurations as discussed hereinbefore with regard to the hydrogen selective membrane separation units (4, 11).

As a result of passing the second hydrogen lean residue stream (13) through the carbon dioxide selective membrane separation unit (14), two separate streams are formed—a carbon dioxide enriched permeate stream (15) and a carbon dioxide depleted residue stream (16) wherein the enrichment and depletion of carbon dioxide is with reference to the feed stream fed to the carbon dioxide selective membrane separation unit (14). The carbon dioxide enriched permeate stream (15) may be further utilized in a variety of manners. More specifically, the carbon dioxide enriched permeate stream (15) may be recycled to the process stream (1) from the process unit (0) where is it added to the process stream (1) prior to the compressor (2) (as shown in FIG. 1) or within the compressor (2) between two of the stages of compression (not shown in FIG. 1) or optionally compressing the carbon dioxide enriched permeate stream (15) and recycling the optionally compressed carbon dioxide enriched permeate stream (15) to be used as a supplemental feed stream in other processes such as a supplemental feed stream for a water gas shift reactor in a hydrogen production plant. The carbon dioxide enriched permeate stream (14) may also be recycled directly back to the carbon dioxide separation unit (8) for further processing.

The carbon dioxide depleted residue stream (16) that is obtained from the carbon dioxide selective membrane separation unit (14) can be withdrawn for further use. For example, the carbon dioxide depleted residue stream (12) can be used as a fuel (for example as a steam methane reformer fuel), as a feed stream (for example as a steam methane reformer feed stream) or as both a fuel and a feed stream in other processes such as in a hydrogen generation plant. In addition, the carbon dioxide depleted residue stream (16) can be used to regenerate any dryers that may be positioned within the process schematic of the present invention to remove moisture, thereby increasing the efficiency of carbon dioxide removal in the carbon dioxide separation unit (8) at lower temperatures.

The operating temperatures for the hydrogen selective membranes and the carbon dioxide selective membranes are each independently selected based on the physical properties of each membrane such that it is mechanically stable and a sufficient gas flux can be maintained across the membrane. Typically, the stream being fed to each of the membrane separation units (4, 11, 14) will be heated or cooled, if necessary, to a temperature which ranges from about −55° C. to about 150° C. In other words, the process of membrane separation in each of these units (4, 11, 14) typically operates at the noted temperature. In one alternative, the second hydrogen lean reside stream (13) is fed into the carbon dioxide selective membrane unit (14) at low to sub-ambient temperatures, preferably from −55° C. to about 30° C., preferably from −55° C. to about 10° C. In such cases, the carbon dioxide selective membranes are considered cold membranes. In still another alternative, the carbon dioxide lean non-condensable stream (10) from the carbon dioxide separation unit (8) is fed to the second hydrogen selective membrane separation unit (11) after being heated to a temperature from about 50° C. to about 150° C. in an optional heat exchanger 33. With regard to this particular alternative, the heat brought to the carbon dioxide lean non-condensable stream (10) is taken from the process stream (1) after the step of compression.

In an even further still embodiment of the present invention, it is also possible to incorporate an optional water gas shift reactor (40) just prior to the first hydrogen membrane separation unit (4) or just prior to the second hydrogen membrane separation and carbon dioxide membrane separation units (11, 14) in order to further convert any carbon monoxide presenting the process stream (1) or the carbon dioxide lean non-condensable stream (10), respectively. As with the optional water gas shift reactor located along the hydrogen rich permeate stream (5, 12), this water gas shift reactor (40) would also preferably be a low temperature water gas shift reactor as described hereinbefore. The size of the low temperature water gas shift reactor (40) would depend upon the amount of the process stream (1) or the carbon dioxide lean non-condensable stream (5) being processed. Note that when this option is utilized, the membranes utilized in the hydrogen and carbon dioxide membrane units (4, 11, 14) will be designed to address wet syngas.

While the preferred embodiments would be to place the optional water gas shift reactor (38) along the permeate line (5), in a still further embodiment, it would be possible to place a low temperature water gas shift reactor (not shown) just prior to the process unit (0) to treat the feed gas (19).

Additional embodiments of the present invention are depicted in FIGS. 5 to 7. These embodiments relate to a process for producing hydrogen in a hydrogen generation plant from a hydrocarbon containing feed stream (20) (preferably natural gas) and capturing at least 80%, preferably at least 90%, even more preferably at least 99%, and further still approaching or obtaining 100% capture, of the overall emissions of carbon dioxide of a feed gas producing unit (34) utilizing a carbon dioxide separation unit (8) and three membrane separation units (4, 11 and 14). More specifically, in the process of the present invention, the process can be executed in a variety of manners including utilizing a feed gas producing unit (34), a pressure swing adsorption unit (0), a carbon dioxide separation unit (8), a first hydrocarbon selective membrane separation unit (4), a carbon dioxide separation unit (8), a second hydrogen selective membrane separation unit (11) and a carbon dioxide selective membrane separation unit (14). As used herein, the phrase “feed gas producing unit” refers to any unit which produces a feed gas that can be subjected to treatment for the removal of hydrogen. More specifically, the feed gas (19) may be a feed gas (19) from a reformer unit/water gas shift unit, a POx uit, an ATR unit, syngas from a coal gasification unit, refinery off gas or any other gas mixture that contains hydrogen, carbon monoxide and carbon dioxide as components in the gas mixture. The present process is preferably executed in a variety of manners including: A) using one or more pre-reformers (21), a steam methane reformer (23), a water gas shift reactor (25), a pressure swing adsorption unit (0), a first hydrocarbon selective membrane separation unit (4), a carbon dioxide separation unit (8), a second hydrogen selective membrane separation unit (11) and a carbon dioxide selective membrane separation unit (14) or B) a steam methane reformer (23), a water gas shift reactor (25), a first hydrogen selective membrane separation unit (4), a pressure swing adsorption unit (0), a carbon dioxide separation unit (8), a second hydrogen selective membrane separation unit (11) and a carbon dioxide selective membrane separation unit (14).

With regard to these preferred embodiments as shown in FIGS. 5 and 6, a hydrocarbon containing feed stream (20) is optionally pre-reformed in at least one pre-reformer (21) to form a pre-reformed gas stream (22). Pre-reforming is carried out in those cases where it is considered to be advantageous to reform the heavier hydrocarbons in the hydrocarbon containing feed stream (20) thereby reducing cracking on the catalyst in the main steam methane reformer (23) and preventing excessive heat rise in the main reformer. The present process is not meant to be limited by the type of pre-reformer (21) utilized for carrying out the process of the present invention. Accordingly, any pre-reformer (21) that is known in the art may be used in the process of the present invention. The pre-reformer (21) can be a single high pressure (typically from about 25 to about 30 bar) adiabatic vessel where desulfurized natural gas preheated to around 600° C. is fed to a bed filled with pre-reforming catalyst (typically catalyst with a high nickel content). Such vessels typically have an outlet temperature around 400° C. The pre-reformer (21) can also be a series of at least two adiabatic pre-reformers (21) with heating in between the vessels in order to provide additional benefits by minimizing the amount of fuel required and thus the amount of hydrogen to fuel. The advantage of such pre-reformers (21) is that the overall need for fuel to provide direct heat to the reforming reaction is reduced, hence naturally decreasing carbon dioxide production in the plant (leading to the high overall carbon dioxide recovery). In addition, the pre-reformer (21) may be operated in the same manner that is known in the art utilizing general conditions, including temperatures and pressures.

The next step of the preferred process involves reforming the pre-reformed gas stream (22) (or in the case where there is no pre-reforming, the hydrocarbon containing gas stream (20)) in a stream methane reformer unit (23) in order to obtain a syngas stream (24). As with the pre-reformer (21), the present invention is not meant to be limited by the steam methane reformer unit (23) or the process for carrying out the reaction in the steam methane reformer unit (23). Accordingly, any steam methane reformer unit (23) known in the art may be used in the process of the present invention. By way of general description, with regard to the steam methane reformer unit (23) of FIGS. 5 and 6, the pre-reformed gas stream (22) (or hydrocarbon containing gas stream (20)) will be combined with high pressure steam (not shown in FIG. 5) before entering the steam methane reforming unit (23). Such steam methane refomer units (23) typically contain tubes (not shown) packed with catalyst (typically a nickel catalyst) through which the steam and gas stream (22) mixtures pass. An elevated temperature of about 860° C. is typically maintained to drive the reaction which is endothermic. As used throughout with regard to the present invention, the phrase “steam methane reformer unit” refers not only to the actual reformer units, but also to all of the additional components that typically are considered to make up a steam methane reformer, including, but not limited to, one or more components selected from heat exchangers, the reformer, tubes with one or more types of catalyst, etc. Prior to be introduced into the actual reformer of the steam methane reformer (23), the stream to be treated will typically be compressed, e.g. to about 200 to 600 psig, and combined with the steam as described hereinbefore. In those instances where pre-reforming is utilized, the stream to be pre-reformed will typically be compressed to e.g., about 200 to 600 psig, thereby resulting in a pre-reformed gas stream (22) which does not require further compression before being introduced into the steam methane reformer (23). The reaction product from the steam methane reformer unit (23) is principally a hydrogen rich effluent that contains hydrogen, carbon monoxide, methane, water vapor and carbon dioxide in proportions close to equilibrium amounts at the elevated temperature and pressure. This effluent is referred to as the syngas stream (24) in the present process.

Once the reforming is carried out, the resulting syngas stream (24) is subjected to a shift reaction in a water gas shift reactor (25) in order to obtain a feed gas (19). The syngas stream (24) is subjected to a shift reaction due to the high amount of carbon monoxide that is often present due to the steam methane reforming (the amount of carbon monoxide actually depends upon the composition of the initial stream injected into the steam methane reformer unit (23)). The water gas shift reactor (25) functions to form additional hydrogen and carbon dioxide by further reacting or treating the syngas stream (24) with additional steam in order to obtain a feed gas (19) for the process unit (0). The syngas stream (24) is introduced into the water gas shift reactor (25) (which can contain a variety of stages or one stage; various stages not shown) along with steam (not shown) to form additional hydrogen and carbon dioxide. The water gas shift reactor (25) converts the carbon monoxide to carbon dioxide with the liberation of additional hydrogen by reaction at high temperature in the presence of the additional steam. Such reactors (25) typically operate at a temperature from about 200° C. to about 500° C. In some cases the stream from the steam methane reformer (23) will be at a higher temperature so optionally the stream may first be cooled with a heat exchanger (typically a steam generator—not shown) before being passed through the water gas shift reactor (25). In a preferred alternative, the water gas shift reactor (25) is a multiple stage water gas shift reactor which includes high temperature shift (typically about 371° C. or above), medium temperature shift (typically around 288° C.), low temperature shift (typically about 177° C. to 204° C.) or any combination thereof. Such multiple shift water gas shift reactors are known and are used to concentrate the amount of carbon dioxide in the resulting gas stream by the manner in which the shifts are arranged (with the high temperature shift resulting in less carbon monoxide reaction and the low temperature shift resulting in more carbon monoxide reaction).

The feed gas (19) from the water gas shift reactor (25) is then subjected to the process as described hereinbefore involving a process unit (0), a first hydrogen selective membrane separation unit (4), a carbon dioxide separation unit (8), a second hydrogen selective membrane separation unit (11), and a carbon dioxide membrane separation unit (14), each as described hereinbefore.

In this particular embodiment as depicted in FIG. 5, the feed gas (19) is introduced into the process unit (0) (in this particular case a pressure swing adsorption unit) where it undergoes pressure swing adsorption to produce a hydrogen product stream (27) and a process steam (1). While the hydrogen product stream (27) is recovered as product, a portion of this stream (27) can be recycled for use for hydrogen fueling of the steam methane reformer (23). As noted previously, the process stream (1) may optionally be completely compressed in the compressor (2) or partially compressed in the compressor (2) or completely compressed in an additional compressor that forms a part of the carbon dioxide separation unit (8) or partially compressed in an additional compressor that forms a part of the carbon dioxide separation unit (8) as described hereinbefore. The temperature of the process stream (1) is adjusted in the heat exchanger (3) prior to the process stream being introduced into the first hydrogen selective membrane separation unit (4). This membrane separation of the process stream (1) results in a first hydrogen rich permeate stream (5) which can be utilized in a variety of manners. The first hydrogen rich permeate stream (5) can be recycled after optionally compressing the stream as a supplemental feed for the steam methane reformer (23), the water gas shift reactor (25) or the process unit (0) or it can be recycled as fuel for the steam methane reformer (23). The hydrogen lean residue stream (6) from the first hydrogen selective membrane separation unit (4) is then cooled in the second heat exchanger (7) prior to be subjected to separation/purification steps of the carbon dioxide separation unit (8). As a result of treating the hydrogen lean residue stream (6) in the carbon dioxide separation unit (8), a carbon dioxide rich liquid stream (9) (which can be vaporized) is produced. This steam (9) is withdrawn from the carbon dioxide separation unit (8) where it can be used as carbon dioxide product. The remaining components from the first hydrogen lean residue stream (6) form a carbon dioxide lean non-condensable stream (10) which is then passed through a second hydrogen selective membrane separation unit (11) thereby forming a second hydrogen rich permeate stream (12) and a second hydrogen lean residue stream (13). As noted in the previously described process of FIG. 1, the second hydrogen rich permeate stream (12) may be optionally compressed in a compressor (28) and recycled to be used as supplemental feed for the process unit (0).

However, when the present embodiment is utilized in a hydrogen generation plant as shown in FIG. 5, in addition to being recycled for use as a supplemental feed for the process unit (0), the hydrogen rich permeate stream (12) may also be used as supplemental feed stream for a steam methane reformer (23) and/or for a water gas shift reactor (25) after optionally compressing the stream (12). Accordingly, with regard to the preferred embodiment, the hydrogen rich permeate stream (5) may be recycled as a supplemental feed for one or more of 1) the process unit (0), 2) the steam methane reformer (23) and 3) the water gas shift reactor (25). Also, the hydrogen rich permeate stream 5 may be utilized as a supplemental fuel for a steam methane reformer (23). It is especially preferable to use the hydrogen rich permeate stream (12) as a fuel to the steam methane reformer (23) since doing so can result boost the percentage of carbon dioxide capture. In addition, by doing so, it is possible to eliminate or reduce the carbon dioxide emissions from the steam methane reformer (23) as the natural gas fuel has been eliminated/minimized.

In another embodiment as depicted in FIG. 6, the hydrogen rich permeate stream (5) can be used as a supplemental feed for the process unit (0) with the objective of increasing hydrogen production. In a still further alternative embodiment also depicted in FIG. 6, the hydrogen rich permeate stream (5) can be used as a supplemental feed for the water gas shift reactor (25) with the objective of driving the reaction towards the production of more carbon dioxide and hydrogen (converting more of the carbon monoxide into carbon dioxide and hydrogen). In a still further embodiment also depicted in FIG. 6, the process unit (0) is a pressure swing adsorption unit (0) and the hydrogen rich permeate stream (5) is utilized as two separate fractions—as a first hydrogen rich permeate fraction (5.1) to be used as a supplemental feed stream in the water gas shift reactor (25) and as a second hydrogen rich permeate fraction (5.2) to be used as a supplemental feed stream in the pressure swing adsorption unit (0). For purposes of FIG. 6, the remaining recycle streams that are noted in FIG. 5 have been omitted in order to concentrate specifically upon the recycle of the fractions (5.1, 5.2) of the hydrogen rich permeate stream (5). With regard to this particular embodiment, the objective is to optimize the use of the recycle stream (5) in order to maximize the conversion of carbon monoxide to carbon dioxide and hydrogen while at the same time maximizing the production of hydrogen product.

With regard to this particular embodiment, the proportion of each fraction recycled to the corresponding devices (0, 25) depends upon the percentage of production (the load) from the steam methane reformer (23). Those of ordinary skill in the art will recognize that a number of factors can contribute to the determination of the load for the steam methane reformer (23) including, but not limited to, the design of the plant, the size of the various components such as the steam methane reformer (23), water gas shift reactor (25), the pressure swing adsorption unit (0), heat exchangers, carbon dioxide removal unit, etc. With regard to this particular embodiment, the shift reaction is maximized utilizing a portion of the recycle stream (5.1) while the remaining portion of the recycle stream (5.2) is sent to the pressure swing adsorption unit (0). This is accomplished by first directing the flow of the hydrogen rich permeate stream (5) to be added to the syngas stream (24) that is to be fed into the water gas shift reactor (25). As noted, the quantity of this first fraction (5.1) is determined by the load of the steam methane reformer unit (23). More specifically, when the steam methane reformer unit (23) is running at full load or capacity, a much higher flow is being sent to the water gas shift unit (25) and consequently, a much higher flow is being sent further downstream. Accordingly, for plants that are retrofitted and not specifically designed to handle this degree of flow of recycle, there may exist limitations on shift capacity, heat exchanger duties, etc. Therefore, in some instances, there may be limitations when the entire recycle (5) is added prior to the water gas shift unit (25). However, it is desirable to recycle to the water gas shift reactor (25) as an ultimate increase in hydrogen production can be seen (an increase of up to 15% or more). In those instances where the recycle (5) is simply sent to the stream (19) before the pressure swing adsorption unit (0), there may still be capacity issues with regard to the actual pressure swing adsorption unit (0) and the downstream compressors. Even so, this option is also desirable as an increase in hydrogen production can also be obtained with this option.

The optimum solution is to split the hydrogen rich permeate stream (5) with one part or fraction going to the water gas shift reactor (23) and the other part or fraction going to the pressure swing adsorption unit (0). With regard to this embodiment, it is preferable to first direct as much as possible of the flow of the recycle (5.1) to the syngas stream (24) before the water gas shift reactor (25) until the water gas shift reactor (25) reaches it maximum capacity (being determined in part by the steam methane reformer (23) load) or unit 100% of the recycle stream (5.1) is recycled to the water gas shift reactor (25) and then directing the remaining fraction (5.2), if any, to the pressure swing adsorption unit (0). Note that with regard to each of these options, the permeate stream is optionally first compressed in a compressor (17) before being recycled to the noted point.

As used herein the phrase “steam methane reformer load” refers to the actual volume of the gas stream processed in the steam methane reformer (23) compared to the volume that the steam methane reformer (23) is capable of processing. For example, if the steam methane reformer is capable of processing 50,000 standard cubic meters of natural gas but only processes 45,000 standard cubic meters of natural gas, then the load would be considered to be 90%. When the load from the steam methane reformer unit (23) is considered to be relatively low, a larger proportion of the recycle will go to the water gas shift reactor (25) rather than to the pressure swing adsorption unit (0). Those skilled in the art will recognize that the load for the steam methane reformer (23) will depend upon any number of a variety of variables such as the size of the plant, the size of the steam methane reformer (23), the size of the equipment utilized downstream, and the composition of the natural gas stream. Accordingly, the phrase “relatively low” when used in terms of the steam methane reformer load operated under standard conditions that are known to those skilled in the art, refers to those instances where the load with regard to the steam methane reformer (23) is, for example, less than or equal to 85%. In such instances, often the first hydrogen rich permeate fraction (5.1) will be greater than the second hydrogen rich permeate fraction (5.2) in terms of quantity. In other words, the first hydrogen rich permeate will comprise greater than 50% of the total amount of the hydrogen rich permeate stream (5). Otherwise, in those instances where the steam methane reforemer (23) load is greater than 85%, preferably greater than 90%, the second hydrogen rich permeate stream will range from greater than 50% of the hydrogen rich permeate stream (5) up to 100% of the hydrogen rich permeate stream (5).

In a still further modification to this embodiment, it is advantageous to further heat the first hydrogen rich permeate fraction (5.1) prior to this stream being added as a supplemental feed to the syngas stream of line (24). This combined fraction (5.1) and syngas stream (24) are then fed into the water gas shift reactor (25). While this heating may be carried out in any manner known in the art, preferably the first hydrogen rich permeate fraction (5.1) is heated utilizing a heat exchanger (36) specifically for this permeate fraction (5.1). In addition to heating this first hydrogen rich permeate fraction (5.1) before adding the fraction to the syngas stream (24), steam can be injected into this fraction (5.1) via line (35) just prior to the fraction (5.1) being mixed with the syngas stream (24). The heating of this first hydrogen rich permeate fraction (5.1) further improves the efficiency of the recycle. By injecting steam into this fraction (5.1), it is possible to avoid steam condensation (which is detrimental to the catalyst in the water gas shift reactor (25)) when mixed with the syngas stream (24). In addition, by injecting steam at this point, it will be possible to further drive the carbon monoxide shift.

With regard to both FIGS. 5 and 6, the hydrogen lean residue stream (6) from the first hydrogen selective membrane separation unit (4) is then cooled in the second heat exchanger (7) prior to be subjected to separation/purification steps of the carbon dioxide separation unit (8). As a result of treating the hydrogen lean residue stream (6) in the carbon dioxide separation unit (8), a carbon dioxide rich liquid stream (9) (which can be vaporized) is produced. This steam (9) is withdrawn from the carbon dioxide separation unit (8) where it can be used as carbon dioxide product. The remaining components from the first hydrogen lean residue stream (6) form a carbon dioxide lean non-condensable stream (10) which is then passed through a second hydrogen selective membrane separation unit (11) thereby forming a second hydrogen rich permeate stream (12) and a second hydrogen lean residue stream (13). In both FIGS. 5 and 6, this second hydrogen permeate stream (12) is optionally compressed in a compressor (28) and recycled to be used as supplemental feed for the process unit (0).

In FIG. 5, the hydrogen rich permeate stream (12) may also be used as supplemental feed stream for a steam methane reformer (23) and/or for a water gas shift reactor (25) after optionally compressing the stream and/or or as a supplemental fuel for a steam methane reformer (23). As with regard to stream (5) in FIG. 5, it is especially preferable to use the hydrogen rich permeate stream (12) as a fuel to the steam methane reformer (23) since doing so can result in a boost of percentage of carbon dioxide capture. In addition, by doing so, it is possible to eliminate or reduce the carbon dioxide emissions from the steam methane reformer (23) as the natural gas fuel has been eliminated/minimized.

In the more preferred embodiment of the present process as depicted in FIG. 6, the second hydrogen rich permeate stream (12) is treated in the same manner as the first hydrogen permeate stream (5) as set forth in FIG. 6. In one alternative, the hydrogen rich permeate stream (12) is used as a supplemental feed for the process unit (0) with the objective of increasing hydrogen production. In a still further alternative as also depicted in FIG. 6, the hydrogen rich permeate stream (12) is used as a supplemental feed for the water gas shift reactor (25) with the objective of driving the reaction towards the production of more carbon dioxide and hydrogen (converting more of the carbon monoxide into carbon dioxide and hydrogen). In a still further embodiment also depicted in FIG. 6, the process unit (0) is a pressure swing adsorption unit (0) and the hydrogen rich permeate stream (12) is utilized as two separate fractions—as a first-second hydrogen rich permeate fraction (12.1) to be used as a supplemental feed stream in the water gas shift reactor (25) and as a second-second hydrogen rich permeate fraction (12.2) to be used as a supplemental feed stream in the pressure swing adsorption unit (0). As noted hereinbefore, with regard to this particular embodiment, the objective is to optimize the use of the recycle stream (12) in order to maximize the conversion of carbon monoxide to carbon dioxide and hydrogen while at the same time maximizing the production of hydrogen product. This is in addition to the recycle of the first hydrogen rich permeate stream (5).

With regard to this particular embodiment, one preferred manner of achieving the objective is to combine the first hydrogen rich permeate stream (5) and the second hydrogen rich permeate stream (12). Accordingly, in this embodiment, stream (12) would simply be fed into stream (5) (not shown). However, these two streams (5, 12) may also be utilized separately. For purposes of the description and as noted in FIG. 6, they shall be treated as two separate streams. As with stream (5), the proportion of each fraction (12.1, 12.2) recycled to the corresponding devices (0, 25) depends upon the percentage of production (the load) from the steam methane reformer (23). As noted before, a number of factors can contribute to the determination of the load for the steam methane reformer (23). With regard to this particular embodiment, the shift reaction is maximized utilizing a portion of the recycle stream (12.1) while the remaining portion of the recycle stream (12.2) is sent to the pressure swing adsorption unit (0). This is accomplished by first directing the flow of the hydrogen rich permeate stream (12) to be added to the syngas stream (24) that is to be fed into the water gas shift reactor (25). When the stream methane reformer unit (23) is running at full load or capacity, a much higher flow is being sent to the water gas shift unit (25) and consequently, a much higher flow is being sent further downstream. Accordingly, for plants that are retrofitted and not specifically designed to handle this degree of flow of recycle, there may exist limitations on shift capacity, heat exchanger duties, etc. Therefore, in some instances, there may be limitations when the entire recycle (12) is added prior to the water gas shift unit (25).

The optimum solution is to split the hydrogen rich permeate stream (12) with one part or fraction going to the water gas shift reactor (23) and the other part or fraction going to the pressure swing adsorption unit (0). With regard to this embodiment, it is preferable to first direct as much as possible of the flow of the recycle (12.1) to the syngas stream (24) before the water gas shift reactor (25) until the water gas shift reactor (25) reaches it maximum capacity (being determined in part by the steam methane reformer (23) load) or unit 100% of the recycle stream (12.1) is recycled to the water gas shift reactor (25) and then directing the remaining fraction (12.2), if any, to the pressure swing adsorption unit (0). Note that with regard to each of these options, the permeate stream is optionally first compressed in a compressor (28) before being recycled to the noted point.

In a still further modification to this embodiment, it is advantageous to further heat the first hydrogen rich permeate fraction (12.1) prior to this stream being added as a supplemental feed to the syngas stream of line (24). This combined fraction (12.1) and syngas stream (24) are then fed into the water gas shift reactor (25). While this heating may be carried out in any manner known in the art, preferably the first hydrogen rich permeate fraction (12.1) is heated utilizing a heat exchanger (37) specifically for this permeate fraction (12.1). In addition to heating this first hydrogen rich permeate fraction (12.1) before adding the fraction to the syngas stream (20), steam can be injected into this fraction (12.1) via line (35) just prior to the fraction (12.1) being mixed with the syngas stream (24). The heating of this first hydrogen rich permeate fraction (12.1) further improves the efficiency of the recycle. By injecting steam into this fraction (12.1), it is possible to avoid steam condensation (which is detrimental to the catalyst in the water gas shift reactor (25)) when mixed with the syngas stream (24). In addition, by injecting steam at this point, it will be possible to further drive the carbon monoxide shift.

As note, the most preferred embodiment would be to add the second hydrogen rich permeate stream (12) to the first hydrogen rich permeate stream (5) and to treat the two streams as one stream, the treatment being as set forth in the description for the first hydrogen rich permeate stream (5) hereinbefore.

Note that with regard to the hydrogen production and carbon dioxide capture embodiments, an optional water gas shift reactor (38, 39) may also be utilized to shift away carbon monoxide in the hydrogen permeate stream (5, 12) as discussed hereinbefore. Preferably such a water gas shift unit (38, 39) would be a low temperature water gas shift unit as defined hereinbefore. In addition with regard to these embodiments, an optional water gas shift reactor (40) may also be utilized prior to the first hydrogen membrane separation unit (4) or the second hydrogen and carbon dioxide membrane units (11, 14) as defined hereinbefore. Finally, a low temperature water gas shift reactor (not shown) may also be considered to be placed just prior to the process unit (0) to treat the feed gas (19).

In the next step of the process of FIGS. 5 and 6, the hydrogen lean residue stream (13) is passed through the carbon dioxide selective membrane separation unit (14) thereby forming a carbon dioxide enrich permeate stream (15) and a carbon dioxide depleted residue stream (16) as described hereinbefore. The carbon dioxide enriched permeate stream (15) can be recycled in a variety of manners including 1) to the process stream (1) from the process unit (0) where is it added to the process stream (1) just prior to the compressor (2) (as shown in FIG. 5) or within the compressor (2) between two of the stages of compression (not shown in FIG. 5); 2) optionally compressing the carbon dioxide enriched permeate stream (15) and recycling the optionally compressed carbon dioxide enriched permeate stream (15) to be used as a supplemental feed stream for processes other than the present process; or recycled directly back to the carbon dioxide separation unit (8) for further processing after being compressed in a compressor (not shown). The carbon dioxide depleted residue stream (16) that is recovered, after optionally being turbo expanded in a turbo expander (26) (in order to recover compressed gas energy and use this energy to drive other components of the process) can be used as a supplemental feed for the pre-reformer (21) or the steam methane reformer (23). While it is also possible to use the carbon dioxide depleted residue stream (16) as a supplemental fuel for the steam methane reformer (23), when higher levels of capture are desirable, the amount of residue stream (16) used as fuel will need to be minimized (when levels approaching 90% are desired) or eliminated (when levels of carbon dioxide capture approaching 100% are desired).

With regard to this particular process, it is possible to achieve an overall capture rate of carbon dioxide that is equal to or greater than 80%, preferably equal to or greater than 90%, even more preferably equal to or greater than 99%, and even still more preferably approaching or achieving 100% capture, when hydrogen fueling is utilized. Those of ordinary skill in the art will recognize that in order to eliminate possible issues such as build up of inerts (e.g., nitrogen) downstream of the pressure swing adsorption unit in the system, it may be desirable to configure the pressure swing adsorption unit to allow for selectivity for those inerts thereby creating a hydrogen stream which is rich in inerts, this hydrogen stream that is rich in inerts to be used as fuel for the steam methane reformer unit (23).

In a still broader aspect of the present invention, the process for producing hydrogen and capturing carbon dioxide from a hydrocarbon containing feed stream (16) in a hydrogen generation plant may be carried out utilizing any feed gas producing unit (34) (see FIG. 7). As noted above, the preferred method is carried out using a steam methane reformer (19) with a water gas shift reactor (21) and an optional pre-reformer (17). However, such feed gas producing units (31) may also include coal gasification units or refinery process units (where the feed gas (19) results from refinery processing; a refinery off gas) or any other feed gas producing unit that produces a gas mixture that contains at least hydrogen, carbon monoxide and carbon dioxide. With regard to the embodiments which contain a gasification unit or a refinery process unit which produces a feed gas, in addition to the hydrogen rich permeate stream (5 and/or 12) being recycled for use as a supplemental feed for the process unit (0), the hydrogen rich permeate stream (5 and/or 12) may also be recycled back to the source (feed gas producing unit 34) that produces the feed gas (19) that is supplied to the process unit (0) (feed gas producing unit 34) to be used as a supplemental feed stream. More specifically, in addition to the hydrogen permeate stream (5 and/or 12) being used in a schematic where it can be used as a supplemental feed stream for the steam hydrocarbon reformer unit/water gas shift unit, this stream (5 and/or 12) may also be used as a supplemental feed stream for a coal gasification unit or refinery process unit or other unit which produces a feed gas stream (19).

Note that the use of the hydrogen selective membranes and the carbon dioxide selective membranes in the manner noted is in order to increase the recovery of hydrogen and carbon dioxide. This can boost hydrogen production and reduce carbon dioxide emissions for the existing plants. It can also reduce the size of reformer, natural gas consumption for the same size new plants with reduced carbon dioxide emissions.

### LIST OF ELEMENTS

0 process unit
1 process stream
2 first compressor
3 first heat exchanger
4 first hydrogen selective membrane separation unit
4.1 permeate side of hydrogen selective membrane
4.2 residue side of hydrogen selective membrane
5 first hydrogen rich permeate stream
5.1 primary fraction of the first hydrogen rich permeate stream
5.2 secondary fraction of the first hydrogen rich permeate stream
6 first hydrogen lean residue stream
7 second heat exchanger
8 carbon dioxide separation unit
9 carbon dioxide rich liquid stream
10 carbon dioxide lean non-condensable stream
11 second hydrogen selective membrane separation unit
11.1 permeate side of hydrogen selective membrane
11.2 residue side of hydrogen selective membrane
12 second hydrogen rich permeate stream
12.1 first-second hydrogen rich permeate stream
12.2 second-second hydrogen rich permeate stream
13 hydrogen lean residue stream
14 carbon dioxide selective membrane separation unit
14.1 permeate side of carbon dioxide selective membrane
14.2 residue side of carbon dioxide selective membrane
15-carbon dioxide enrich permeate stream
16 carbon dioxide depleted residue stream
17 second compressor
18 liquefaction unit
18.1 first liquefaction unit
18.2 second liquefaction unit
19 feed gas
20 hydrocarbon containing feed stream
21 pre-reformer
22 pre-reformed gas stream
23 steam methane reformer unit
24 syngas stream
25 water gas shift reactor
26 turbo expander
   27 hydrogen product stream from pressure swing adsorption
   28 third compressor
   29 distillation column additional compressor
   31 additional heat exchanger
   32 cooling element for additional compressor
   33 optional heat exchanger
   34 feed gas producing unit
35 line for injecting steam into the primary fraction fo the first hydrogen rich permeate stream
36 heat exchanger for recycle stream (5)
37 heat exchanger for recycle stream (12)
38 optional second water gas shift reactor
39 optional third water gas shift reactor
40 optional fourth water gas shift reactor

What is claimed is:

1. A process for recovering hydrogen and carbon dioxide from a process stream (1) of a process unit (0), the process stream containing at least carbon dioxide, hydrogen and methane and the process comprising the steps of:
a) optionally compressing at least a portion of the process stream (1) in a first compressor (2);
b) adjusting the temperature of the optionally compressed portion of the process stream (1) in a heat exchanger (3) to a temperature from 20° C. to 150° C.;
c) passing the temperature adjusted process stream (1) through a first hydrogen selective membrane separation unit (4) to form a first hydrogen rich permeate stream (5) with the remaining components in the process stream (1) forming a first hydrogen lean residue stream (6);
d) optionally compressing the first hydrogen rich permeate stream (5) in a second compressor (17) and then recycling the first hydrogen rich permeate stream (5) for use as a supplemental feed stream in the water gas shift reactor (25), the process unit (0) or in both the water gas shift reactor (25) and the process unit (0);
e) cooling the first hydrocarbon lean residue stream (6) in a heat exchanger (7) to a temperature equal to or less than −10° C.;
f) separating and purifying the cooled first hydrocarbon lean residue stream (6) in a carbon dioxide separation unit (8) to produce a carbon dioxide rich liquid stream (9) and a carbon dioxide lean non-condensable stream (10);
g) withdrawing the carbon dioxide rich liquid stream (9) as carbon dioxide product for further use;
h) withdrawing the carbon dioxide lean non-condensable stream (10) from the carbon dioxide separation unit (8) and passing the carbon dioxide lean non-condensable stream (10) through a second hydrogen selective membrane separation unit (11) to form a second hydrogen rich permeate stream (12) with the remaining components in the carbon dioxide lean non-condensable stream (10) forming a second hydrogen lean residue stream (13);
i) passing the hydrogen lean residue stream (13) through a carbon dioxide selective membrane separation unit (14) to form a carbon dioxide enriched permeate stream (15) with the remaining components in the hydrogen lean residue stream (13) forming a carbon dioxide depleted residue stream (16); and
j) optionally compressing the second hydrogen rich permeate stream (12) in a third compressor (28) and recycling the second hydrogen rich permeate stream (12) for use as a supplemental feed stream in the water gas shift reactor (25), the process unit (0) or both the water gas shift reactor (25) and the process unit (0), recycling the carbon dioxide enriched permeate stream (15) to the process stream (1) prior to the compressor (2) or within the compressor (2) between stages of compression or optionally compressing the carbon dioxide enriched permeate stream (15) and recycling the carbon dioxide enriched permeate stream (15) to be used in the carbon dioxide separation unit (8) and recycling the carbon dioxide depleted residue stream (16) to be used as a fuel for the steam methane reformer (23), as a supplemental feed stream for the pre-reformer (21) or the steam methane reformer (23) or as both a fuel and a feed stream in the present process or in other processes.

2. The process of claim 1, wherein the hydrogen rich permeate stream (8) is subjected to a shift reaction in an optional second water gas shift reactor (32) prior to being recycled to the water gas shift reactor (21), the process unit (0) or both the water gas shift unit (21) and the process unit (0).

3. The process of claim 2, wherein the water gas shift reactor (32) is a low temperature water gas shift reactor.

4. The process of claim 1, wherein the carbon dioxide lean non-condensable stream (5) is subjected to a shift reaction in an optional third water gas shift reactor (33) prior to being passed thorough the hydrogen and carbon dioxide membrane separation units (7, 10).

5. The process of claim 4, wherein the water gas shift reactor (33) is a low temperature water gas shift reactor.
